(19) United States
(12) Patent Application Publication
(10) Pub. No.: US 2025/0131059 A1
(43) Pub. Date: Apr. 24, 2025

(54) SYSTEMS AND METHODS FOR TOWARDS HUMAN-ALIGNED EVALUATION FOR AUTO-FORMULATING OPTIMIZATION MODELING WITH LARGE LANGUAGE MODELS

(71) Applicant: HUAWEI CLOUD COMPUTING TECHNOLOGIES CO., LTD., Gui Zhou Province (CN)

(72) Inventors: Linzi XING, Kanata (CA); Xinglu WANG, Kanata (CA); Zhenan FAN, Kanata (CA); Yuxi FENG, Kanata (CA); Jing XIONG, Kanata (CA); Zhijiang GUO, Kanata (CA); Xiaojin FU, Kanata (CA); Rindranirina RAMAMONJISON, Kanata (CA); Mahdi MOSTAJABDAVEH, Kanata (CA); Xiongwei HAN, Kanata (CA); Zirui ZHOU, Kanata (CA); Yong ZHANG, Kanata (CA)

(73) Assignee: HUAWEI CLOUD COMPUTING TECHNOLOGIES CO., LTD., Gui Zhou Province (CN)

(21) Appl. No.: 18/381,239

(22) Filed: Oct. 18, 2023

(51) Int. Cl. G06F 17/11; G06N 3/0455

(52) U.S. Cl. CPC G06F 17/11; G06N 3/0455

(57) ABSTRACT

A method of evaluating an ability of a large language model (LLM) to generate an accurate hypothesis model (HM) of a linear programming word problem (LPWP) is provided. An attributed bipartite graph of the HM is transformed into an attributed bipartite graph of the ground truth model of the LPWP. The number of transformation steps required for the transformation effectively measures the ability of the LLM to generate an accurate HM. The use of attributed bipartite graphs provide invariance in the order to LPWP variables and constraints. Corresponding apparatus and systems are also provided.

### CROSS-REFERENCE TO RELATED APPLICATIONS

This is the first application filed for the present invention.

### FIELD OF THE INVENTION

The present invention pertains to the field of machine learning and natural language processing, and in particular to systems and methods for obtaining a mathematical form of optimization problems with large language models (LLMs).

### BACKGROUND

Evaluating prediction models, particularly those generated by machine learning models like LLMs for optimization problems such as linear programming word problems (LPWPs), presents a unique set of challenges. One of these challenges revolves around the concept of permutation invariance, where existing evaluation approaches struggle to provide robust support. Ensuring that the model's predictions remain invariant despite permutations of input variables is essential for reliable assessment. Further, confidently identifying model equivalence poses another hurdle. Some evaluation methods may mistakenly deem a prediction model equivalent to its reference counterpart solely based on the model yielding an optimal objective value that aligns with the reference. This oversight can occur even when the prediction model overlooks only one constraints. In some cases, seemingly non-identical models may produce “infeasible” results, where the optimal objective value is erroneously considered to be a correct prediction due to these complexities. Addressing these challenges in evaluating prediction models for optimization problems is important for enhancing model reliability and applicability in real-world scenarios.

Therefore, improvements in obtaining a mathematical form of an optimization problem with LLMs are desirable.

This background information is provided to reveal information believed by the applicant to be of possible relevance to the present invention. No admission is necessarily intended, nor should be construed, that any of the preceding information constitutes prior art against the present invention.

### SUMMARY

Apparatus, systems, and methods for towards human-aligned evaluation for auto-formulating optimization modeling with LLMs. According to an aspect, the present disclosure provides a computer-implemented method for evaluating an accuracy of a hypothesis model (HM) against a ground truth model (GTM). The method comprises obtaining a graph of the HM. The graph of the MHM contains HM constraints vertices associated with HM constraints, HM variables vertices associated with HM variables, and HM edges connecting the HM constraints vertices to the HM variables vertices. The method further comprises obtaining a graph of the GTM. The graph of the GTM contains GTM constraints vertices associated with GTM constraints, GTM variables vertices associated with GTM variables, and GTM edges connecting the GTM constraints vertices to the GTM variables vertices. Furthermore, the method comprises transforming the graph of the HM into the graph of the GTM through a series of transformation steps. A total number of the transformation steps to transform the graph of the HM into the graph of the GTM being a measure of the accuracy of the HM.

In some embodiments of the first aspect, transforming the graph of the HM into the graph of the GTM includes automatically transforming the graph of the HM into the graph of the GTM using a graph edit distance computing algorithm. In some embodiments, the graph edit distance algorithm is based on an A* algorithm. In some embodiments, the graph edit distance computing algorithm is a depth-first graph edit distance algorithm.

In some embodiments of the first aspect, the method may further comprise obtaining the HM by inputting a math word problem into a LLM to generate the HM. Inputting the math word problem into the LLM may include inputting a math word optimization problem into the LLM. In some embodiments, generating the HM may comprise obtaining, from the LLM, the HM variables; a lower bound for each respective HM variable of the HM variables; and an upper bound for each respective HM variable of the HM variables. Generating the HM may further comprise obtaining at least one HM function depending on the HM variables. The at least one function defining an output may be optimized in accordance with the math word problem. Generating the HM may further comprise obtaining one or more HM constraints equation. The one or more HM constraints equation may define the HM constraints placed on the HM variables. Generating the HM may further comprise transforming the at least one HM function and the one or more HM constraints equation into a general linear programming model of the math word problem to obtain the HM.

In some embodiments of the first aspect, the GTM model may have associated thereto a lower bound and an upper bound for each respective GTM variable of the GTM variables. The GTM model may also have at least one GTM function depending on the GTM variables, the at least one GTM function defining an output to be optimized in accordance with the math word problem. Further, the GTM model may also have one or more GTM constraints equation, the one or more GTM constraints equation defining the GTM constraints placed on the GTM variables.

In some embodiments of the first aspect, obtaining the graph of the HM may include forming a HM attributed bipartite graph by generating the HM constraints vertices in accordance with the HM variables and the one or more HM constraints equation. Forming the HM attributed bipartite graph may also include generating the HM variables vertices in accordance with: the HM variables; the lower bound and the upper bound for each respective HM variable of the HM variables; and the at least one HM function. Generating the HM attributed bipartite graph may also include generating the HM edges connecting the HM constraints vertices to the HM variables vertices in accordance with the one or more HM constraints equation. The HM constraints vertices may form a first HM set of vertices. The HM variables vertices may form a second HM set of vertices. The first HM set of vertices and the second HM set of vertices may be disjoint. Obtaining the graph of the GTM may include forming a GTM attributed bipartite graph by generating the GTM constraints vertices in accordance with: the GTM variables; and the one or more GTM constraints equation. Forming the GTM attributed bipartite graph may further include generating the GTM variables vertices in accordance with: the GTM variables; the lower bound and the upper bound for each respective GTM variable of the GTM variables; and the at least one GTM function. Forming the GTM attributed bipartite graph may further include generating the GTM edges connecting the GTM constraints vertices to the GTM variables vertices in accordance with the one or more GTM constraints equation. The GTM constraints vertices may form a first GTM set of vertices. The GTM variables vertices may form a second GTM set of vertices. The first GTM set of vertices and the second GTM set of vertices may be disjoint.

In some embodiments of the first aspect, the HM constraints vertices have associated thereto HM constraints values, the HM variables vertices have associated thereto HM variables values, and the series of transformation steps may include at least one of: a substitution of a HM constraints value with a different HM constraints value; a substitution of a HM variables value with a different HM variables value; an addition of a HM constraints vertex; an addition of a HM variables vertex; a deletion of a HM constraints vertex; a deletion of a HM variables vertex; an addition of an edge connecting an HM constraints vertex to an HM variables vertex; a deletion of a second edge connecting a second HM constraints vertex to a second HM variables vertex; and a substitution of a weight of any edge with a different weight.

In some embodiments of the first aspect, the method may further comprise obtaining an accuracy score in accordance with the total number of transformation steps. The accuracy score may indicate the ability of the LLM to generate accurately the HM. The method may also comprise modifying the LLM in accordance with the accuracy score; and iteratively performing actions A) through G) until a stop criteria is met, where the actions A) through G) are as follow. A) generating a further HM by inputting a further math word problem into the LLM, the further math word problem having associated thereto a further GTM; B) obtaining a graph of the further HM; C) obtaining a graph of the further GTM; D) transforming the graph of the further HM into the graph of the further GTM through a series of further transformation steps, a total number of the further transformation steps to transform the graph of the further HM into the graph of the further GTM being a measure of the accuracy of the further HM; E) obtaining a further accuracy score in accordance with the total number of the further transformation steps, the further accuracy score indicating the ability of the LLM to generate accurately the further HM; F) modifying the LLM in accordance with the accuracy score; and G) determining if the stop criteria is met.

In some embodiments of the first aspect, obtaining a first graph representation may comprise: obtaining a first set of graph representations of a first set of optimization models generated by the machine learning model based on a first set of optimization problems. Each graph representation of the first set of graph representations may correspond to an optimization model of the first set of optimization models based on the corresponding optimization problem of the first set of optimization problems. Obtaining a second graph representation may comprise: obtaining a second set of graph representations of a second set of optimization models serving as ground truth for the first set of optimization problems. Each graph representation of the second set of graph representations may correspond to an optimization model of the second set of optimization models based on the corresponding optimization problem of the first set of optimization problems. Obtaining a minimum number of edit operations may comprise: obtaining a set of edit operations to transform the first set of graph representations to the second set of graph representations.

In some embodiments of the first aspect, obtaining a set of edit operations to transform the first set of graph representations to the second set of graph representations may comprise obtaining, for said each optimization problem, a sequence of one or more edit operations of the set of edit operations to transform a corresponding graph of the first set of graph representations to a corresponding graph representation of the second set of graph representations.

In some embodiments of the first aspect, the method may further comprise obtaining a set of graph edit distances (GEDs) corresponding to the set of edit operations. Each GED may correspond to said each optimization problem and indicating a measure of the corresponding sequence of the one or more edit operations. The method may further comprise obtaining one or more of: a ratio of exact match based on the set of GEDs. The ratio of exact match may indicate a proportion of the first set of optimization models having a corresponding GED of the set of GEDs indicating an equivalent match; and a mean of GEDs based on the set of GEDs.

In some embodiments of the first aspect, the method may further comprise adjusting one or more weights of the machine learning model based on the set of edit operations. The machine learning model may comprise a plurality of nodes connected with one another via a plurality of connections. The machine learning model further comprise the one or more weights corresponding to the plurality of connections.

In some embodiments of the first aspect, the method may further comprise generating a training dataset based on the set of edit operations, the training dataset comprising a second set of optimization problems. The method may further comprise training the machine learning model using the second set of training dataset.

In some embodiments of the first aspect, training the machine learning model using the training dataset may comprises feeding the second set of training dataset into the machine learning model, and obtaining a third set of optimization models generated by the machine learning model based on the second set of optimization problems. Training the machine learning model using the training dataset may also comprise obtaining a third set of graph representations of the third set of optimization models, where each graph representation of the third set of graph representations corresponds to an optimization model of the third set of optimization models based on a corresponding optimization problem of the second set of optimization problems. Training the machine learning model using the training dataset may also comprise obtaining a fourth set of graph representations of a fourth set of optimization models serving as ground truth for the second set of optimization problems, each graph representation of the fourth set of graph representations corresponding to an optimization model of the fourth set of optimization models based on the corresponding optimization problem of the second set of optimization problems. Further, training the machine learning model using the training dataset may also comprise obtaining a second set of edit operations to transform the third set of graph representations to the fourth set of graph representations, and adjusting the one or more weights of the machine learning model based on the second set of edit operations.

In some embodiments of the second aspect, the method may further comprise obtaining a set of reward signals based on the set of edit operations, where each reward signal indicates a quality of an optimization model of the first set of optimization models with respect to a corresponding optimization model of the second set of optimization models. Adjusting one or more weights of the machine learning model based on the set of edit operations may comprise adjusting the one or more weights of the machine learning based on the set of reward signals using reinforcement learning.

In a third aspect, the present disclosure provides a computer-implemented method for evaluating an accuracy of a LLM, where the accuracy is in generating a HM of a corresponding LPWP. The method comprises obtaining, from the LLM, a plurality of HMs corresponding to a plurality of LPWPs, each LPWP of the plurality of LPWPs having associated thereto a respective GTM, all the respective GTMs forming a plurality of GTMs, each HM of the plurality of HMs having associated thereto a respective GTM of the plurality of GTMs. The method further comprises, for each HM of the plurality of HMs: obtaining a graph of the HM; and obtaining a graph of the GTM associated with the HM. The graph of the HM contains HM constraints vertices associated with HM constraints, HM variables vertices associated with HM variables, and HM edges connecting the HM constraints vertices to the HM variables vertices. The graph of the GTM contains GTM constraints vertices associated with GTM constraints, GTM variables vertices associated with GTM variables, and GTM edges connecting the GTM constraints vertices to the GTM variables vertices. The method further comprises transforming the graph of the HM into the graph of the GTM through a sequence of transformation steps having a total number of transformation steps. The method also comprises calculating a score representing the accuracy of the LLM, the score being a function of all the total numbers of transformation steps for transforming all the HM graphs associated with plurality of HMs into all the respective GTM graphs associated with the plurality of GTMs.

In a fourth aspect, the present disclosure provides a method that comprises obtaining a first graph representation of a hypothesis optimization problem model generated by a machine learning model based on an optimization problem. The method also comprises obtaining a second graph representation of a reference optimization problem model based on the optimization problem. The method further comprises obtaining a minimum number of edit operations to transform the first graph representation into the second graph representation. The minimum number of operations indicates a performance of the machine learning model.

In some embodiments of the fourth aspect, the machine learning model may be a LLM and the optimization problem may be one of: a LPWP; a mixed integer linear programming problem; a quadratic programming problem; and a quadratically constrained quadratic programming problem. The first graph representation may be a first attributed bipartite graph. The second graph representation may be a second attributed bipartite graph. The minimum number of operations may be a function of a graph edit distance between the first attributed bipartite graph and the second attributed bipartite graph.

In some embodiments of the fourth aspect, the optimization problem may include a set of constraints, and a set of decision variables, and the method may further comprise obtaining a first general form of linear programming corresponding to the hypothesis optimization problem model; and obtaining a second general form of linear programming corresponding to the reference optimization problem model.

In some embodiments of the fourth aspect, the minimum number of edit operations may a minimum sequence of edit operations to transform the first attributed bipartite to the second attributed bipartite graph. In some embodiments, the minimum sequence of edit operations relate to one or more of: a vertex of the first set of vertices, a vertex of the second set of vertices, an edge of the set of edges. In some embodiments, the minimum sequence of edit operations may relate to one or more of: an insertion operation, a deletion operation, and a substitution operation.

In some embodiments of the fourth aspect, the method may further comprise obtaining a total cost for the minimum sequence of edit operations based on a cost value assigned for each edit operation of the minimum sequence of edit operations. The total cost may be indicative of the performance of the machine learning model.

According to another aspect, an apparatus may be provided. The apparatus includes modules or electronics configured to perform one or more of the methods and systems described herein.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of an optimization problem is a LPWP, in accordance with the present disclosure.

FIG. 2 illustrates examples showing difficulties with canonical accuracy.

FIG. 3 illustrates two scenarios where execution accuracy is deficient.

FIG. 4 illustrates an attributed bipartite graph, according to an embodiment of the present disclosure.

FIG. 5A illustrates an embodiment of a graph edit path between a hypothesis graph and a reference graph.

FIG. 5B illustrates an embodiment of another graph edit path between a hypothesis graph and a reference graph.

FIG. 6 illustrates a flowchart of an embodiment of a method according to the present disclosure.

FIG. 7A illustrates a flow of an embodiment of a method according to the present disclosure.

FIG. 7B illustrates a flowchart of an embodiment of a method according to the present disclosure.

FIG. 8 illustrates a flow of an embodiment of a method according to the present disclosure.

FIG. 9 illustrates an embodiment apparatus according to the present disclosure.

It will be noted that throughout the appended drawings, like features are identified by like reference numerals.

### DETAILED DESCRIPTION

Apparatus, systems, and methods may be provided for human-aligned evaluation for auto-formulating optimization modeling with LLMs.

As used herein, a math word problem refers to a problem that aims to provide a solution expression in response to a given mathematical problem description (or a linear programming mathematical problem description) presented as a textual narrative rather than in mathematical notation. Natural Language Processing (NLP) is a field of artificial intelligence that focuses on the interaction between computers and humans through natural language, enabling computers to understand, interpret, and generate human languages in a way that is meaningful. Text generation may refer to generation of human-interpretable text, and a task of text generation is a subfield of NLP which aims to create human-interpretable text. Entity recognition may refer to the task of identifying and classifying named entities, such as people, organizations, locations, and other specific terms, within a text.

Arithmetic problems refer to mathematical questions that involve calculations using basic operations like addition, subtraction, multiplication, and division. An algebra problem involves finding unknown values by using mathematical symbols, variables, and equations to represent relationships between quantities.

An optimization problem is a mathematical problem that aims to find the best possible solution from a set of available choices, subject to certain constraints or limitations. The goal is typically to either maximize or minimize a particular objective function while ensuring that the solution meets the constraints.

A LPWP is a type of optimization problem where both the objective function and the constraints are linear. For example, an LPWP may refer to a type of mathematical problem that involves optimizing (e.g., maximizing or minimizing) a linear objective function while adhering to a set of linear constraints. Linear programming may refer to a mathematical technique used to find the best outcome in a mathematical model with linear relationships. In the context of word problems, these scenarios often represent real-world situations where highly diverse human language is describing the real-world problems.

An LPWP may have one objective. The objective may define the goal of the problem (e.g., minimize the cost, maximize the amount of calcium, maximize the number of participants, etc.). An LPWP may further have one or more constraints. The constraints are considerations of the problem either due to real-world limitations (e.g., no negative number of people, less than 20 kg of goods on the truck due to weight limitations) or due to user-specified desires (e.g., at least 10 items sold). An LPWP may further have one or more decision variables (variables) that have values that can be changed to reach the goal of the optimization problem. An optimal solution, in reference to an optimization problem, may refer to value(s) of decision variable(s) that will optimize the objective function while adhering to the constraints.

A math problem description may describe the optimization problem either exclusively with math content or natural language or using both natural language and math content. A problem description would be, for example, how an expert describes the optimization problem to the operations research (OR) expert.

A LLM may refer to a machine learning model trained on vast amounts of text data to generate human-like text based on given input or instruction. The expression “end-to-end” in reference to a process may indicate that the process encompasses all stages or components of a system, ensuring that a task is completed comprehensively from start to finish.

A false positive may refer to an error in data reporting in which a test result improperly indicates the presence of a condition, such as a diagnostic test incorrectly showing a positive result for a disease when it is not actually present. A false negative may refer to, for example, an outcome of a test that incorrectly indicates the absence of a condition (such as a disease or a positive match), even though it is present.

A mathematical model formulation may refer to a method of representing the linear programming optimization problem. A HM may refer to a mathematical model formulation obtained by a LLM. A reference model (or GTM) may refer to a mathematical model formulation used as ground truth in the testing data to compare with the HM to evaluate LLM's performance.

Permutation invariance may refer to a property of a function or a system that remains unchanged or invariant when the elements or items in a set are rearranged (permuted) in a different order. For example, if two mathematical model formulations are just different in terms of the order of variables and constraints, technically, they are still equivalent. An evaluation metric that is considered permutation invariant can correctly reveal that these two formulations as equivalent.

A model equivalence (match) may refer to the equivalence of two optimization models as two models containing the same information covered in the problem description.

A mathematical programming system (MPS) file is a widely supported format for linear and mixed integer programming solvers. Solvers (or optimization solvers) may refer to software tools that take as input the model instance and implement standard algorithms to solve mathematical optimization problems. The term “parsing” may refer to the process of turning an input string of text into smaller segments, also known as tokens. This process is performed by a parser.

A graph edit distance may refer to a measure that quantifies the similarity between two graphs by calculating the minimum cost of transforming one graph into the other through a sequence of edit operations. Edit operations may include, for example, one or more a vertex insertion, a vertex deletion, a vertex substitution, an edge insertion, an edge deletion and an edge substitution.

A bipartite graph (or an attributed bipartite graph) is a type of graph representation whose vertices can be partitioned into two disjoint sets such that no two vertices within the same set are adjacent.

Math word problems (MWPs), as fundamental but challenging NLP tasks, have received considerable attention in recent years. In essence, MWPs aim to provide the solution expression in response to a given mathematical problem description. Most prior research for this task has primarily centered on effectively returning solutions for elementary arithmetic problems and algebra problems, as these problems are easy to model and test, and computational methods for these problems can be evaluated in a relatively straightforward and standardized manner. Nevertheless, another category of math word problem, namely LPWPs, remains largely under-explored.

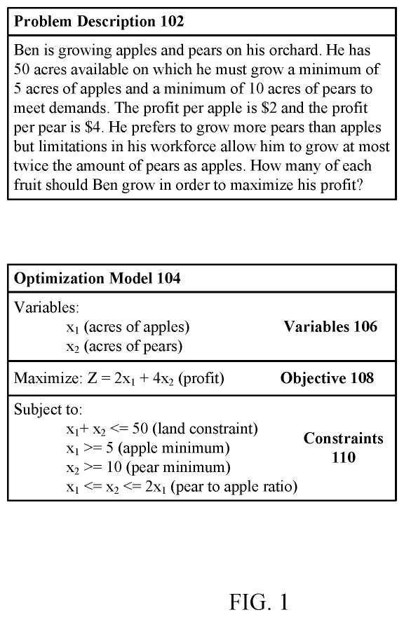

FIG. 1 illustrates an example of an optimization problem being a LPWP expressed as a textual problem description 102 and its paired optimization model formulation 104, where the problem description carries essential information for the model. This optimization model formulation, in turn, may comprise one or more types of components: an objective 108, constraints 110, and decision variables (or variables 106).

While LPWP can more authentically reflect real-world decision-making processes and thus offer considerable potential to benefit the field of operations research (OR), its reasoning-intensive nature may mandate the deconstruction of prior neural solutions into sub-steps (e.g., first entity recognition, then text generation), leading to inevitable error accumulation. Furthermore, the data sparsity issue also introduces extra difficulty for neural approaches to consistently achieve reliable and robust performance. To address the above-mentioned challenges, a problem description can be formulated as an instruction to guide LLMs to produce the optimization model 104 as the answer in an easy-to-process format by using empirically tuned prompt templates. This modeling process can be end-to-end, without requiring ground-truth data in scale.

Some existing evaluation approaches that assess the effectiveness of LLMs on LPWP include canonical accuracy and execution accuracy.

Canonical Accuracy is based on the declaration-level matching between hypothesis and reference model, where a declaration is, by definition, the representation of either an optimization objective or a constraint. In particular, the canonical accuracy for one LPWP problem can be calculated as follows:

$$A c c = 1 - \frac{min ( F {P}_{i} + F {N}_{i} , {D}_{i} )}{{D}_{i}}$$

where for a given problem i, Dᵢ is the number of actual declarations in the ground-truth model. The term false positives FPᵢ denotes the number of declarations in prediction not matching with any of the actual declarations, while false negatives FNᵢ denotes the number of actually correct declarations that fail to appear in the predicted declarations. As FPᵢ+FNᵢ can possibly exceed Dᵢ, the min is leveraged to prevent negative accuracy score.

Execution Accuracy is similar to the prevalent evaluation framework for code generation, which mainly focuses on the functional correctness of program prediction. The execution evaluation strategy for LPWP aims to assess the correctness of the optimization model hypothesized by LLMs via comparing the optimal solutions between hypothesis and reference models. The process includes converting a mathematical model formulation into a mathematical programming system MPS file format, which can then be fed into a solver to derive the optimal objective value. The exact match of optimal objective values between the hypothesis and reference model can be deemed as a successful prediction.

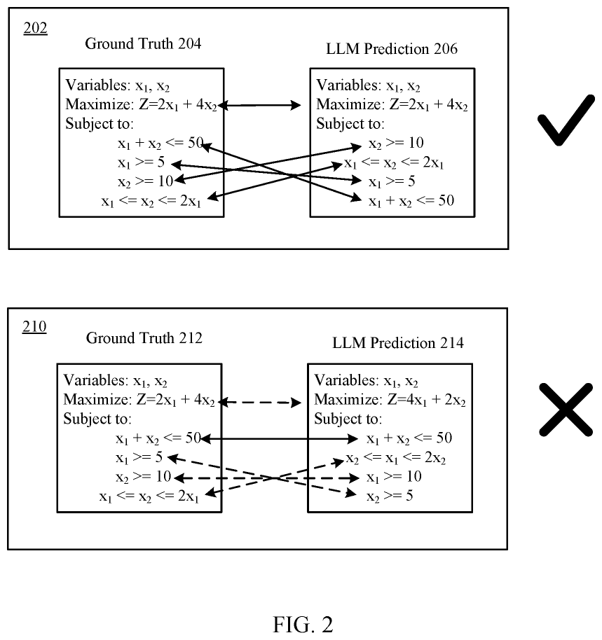

FIG. 2 illustrates examples of canonical accuracy. Although canonical accuracy may resist some permutation of constraints (example 202 in FIG. 2), canonical accuracy is still bound with a strong that LLMs must follow the same order of variables mappings as those in the ground-truth model. For example, even though a.X+b. Y≤c and b.Y+a.X≤c are fundamentally equivalent, a canonical measurement will declare them unequal due to the altered order of variables. As shown in example 210, prediction 214 of the LLM merely swaps variables and constraints in the ground truth 212. However, the canonical method exhibits considerably low accuracy in such a scenario. Therefore, canonical accuracy can easily introduce over penalization as LLMs are not able to adhere to the same and hallucinated variable names often.

In example 202, the order of constraints between ground truth 204 and LLM's prediction 206 is different but the order of variables remains the same. The canonical metric still works in such a case. In example 210, the order of two variables x and y are swapped in LLM prediction 214 compared to the ground truth 212 and all declarations are affected accordingly by this swap. In example 210, canonical accuracy is likely to make mistakes in introducing more false-negative while matching declarations.

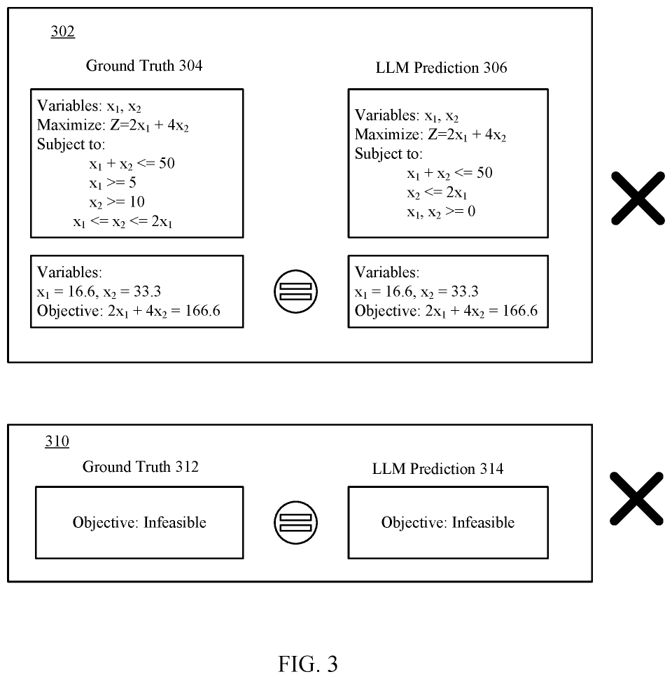

Execution accuracy cannot confidently determine that a HM (a prediction model) is equivalent or an exact match to a GTM. Thus, execution accuracy cannot serve as a faultless indicator of model equivalence. FIG. 3 illustrates two scenarios in which execution accuracy makes incorrect judgement and also illustrates two possible scenarios which will cause the execution evaluation approach to make incorrect judgement about whether the ground truth and LLM's prediction are equivalent or not.

Scenario 302 illustrates an LLM prediction 306 which overlooks a considerable number of constraints compared to the ground truth 304 but yields an optimal objective value that aligns with the reference 304. In the second scenario 310, a pair of non-identical models 312 and 314 yielding “Infeasible” as the optimal objective value will also be regarded as a correct prediction under execution accuracy.

To address the pitfalls of existing evaluation metrics, according to an aspect, an enhanced evaluation metric may be provided. According to an aspect, an evaluation metric may be provided that is simple and effective for evaluating modeling performance of machine learning models (e.g., LLMs) on optimization problems (e.g., LPWPs). According to an aspect, the evaluation metric may allow for variable or constraint permutation invariance and a reliable model exact match identification.

The evaluation metric or the evaluation strategy may be based on graph edit distance. According to an aspect, the evaluation metric may involve using a robust parser to extract mathematical model formulations from the ground truth (reference model) and the answer (hypothesized or prediction model) provided by LLMs. The mathematical model formulations may then be converted into bipartite graphs with weighted edges linking up vertices representing variables and constraints. Graph edit distance may be calculated between the paired hypothesized and reference graphs. The graph edit distance may be used as a metric to assess the accuracy of the predictions made by LLMs. The enhanced evaluation metric may overcome the limitations of the existing evaluation metrics described herein.

The enhanced evaluation metric may allow for permutation invariance. Compared to the canonical measurement approach, the enhanced evaluation metric may better accommodate order discrepancies of variables and constraints between the reference model and the HM, as these constraints or variables' order variations do not inherently indicate that the two models are different.

The enhanced evaluation metric may further allow for exact match identification. Compared to the executable measurement, the enhanced evaluation metric may allow for a more confident detection of equivalent or exact match between the HM and the reference model. The enhanced evaluation metric may further address the problem of executable measurement that two models with the same (infeasible) optimal solution are possibly inequivalent.

According to an aspect, a method (or an evaluation strategy) may be provided for evaluating an LLM's performance based on an optimization problem. The method may be grounded on the graph edit distance between reference models and their corresponding HMs produced by LLMs. The method may successfully tackle the pitfalls of execution and canonical accuracy as described herein. In addition, the method may allow for better alignment with human sense since a smaller graph edit distance indicates fewer mistakes in the HM produced by the LLM and better modeling capability of the LLM.

According to an aspect, the method may include converting mathematical formulations of the HMs produced by an LLM and corresponding reference models into a general form for linear programming (LP). The method may further include converting the general LP model form into a graph representation. In some embodiments, the graph representation may be based on an attributed bipartite graph. The attributed bipartite graph may include a first type of vertices being variables vertices and a second type of vertices being constraints vertices. Each variables vertex may be equipped with one or more attributes including: upper bound, lower bound and a coefficient with respect to the objective. Each constraints vertex may be equipped with one or more attributes including upper bound and lower bound. Each edge between a variables vertex and a constraints vertex may represent a coefficient of the variables vertex with respect to the constraints vertex.

Accordingly, the paired original hypothesis and reference model (GTM) may be transformed into graphs using any suitable rules-based graph convertor. The method may further include determining the graph edit distance between the graph representation of the HM and the graph representation of the corresponding reference model. Determining the graph edit distance may include applying methods for computing graph edit distance to measure the minimum-cost sequence of basic edit operations to transform the graph representation of the HM into the graph representation of the corresponding reference model. The basic edit operations may include one or more of insertion, deletion and substitution of one or more of: vertices and edges. In some embodiments, a graph edit distance of 0 can be confidently interpreted as an exact match between the ground truth and LLM's prediction. Further, since attributes are attached to constraints or variables, this method may also be permutation invariant.

According to an aspect, a method for auto-formulating optimization modeling with LLMs may be provided that allows for improved accuracy and robust evaluation. The method may address pitfalls of prior approaches through permutation invariance and better identification of model exact match.

The method may further allow for integrating available information in other modalities, such as textual explanations. For example, referring to FIG. 1, each model component (declaration) is followed by a text explanation generated by the LLM (e.g., “acres of apples” and “acres of pears” are text explanations generated by the LLM). The method may allow for adding this explanation as another attribute to the corresponding vertex of the graph representation. Further a cost function may be defined for this attribute, and thus, the evaluation metric can potentially be more fine-grained and further aligned with human's perspective. This way, the method may be extended to allow for explanation integration.

According to an aspect, the method may allow for error traceback. In some embodiments, the method may obtain a score or a measure indicating a degree of difference between optimization models. In some embodiments, the method may allow for identifying the mismatches between the HM and the reference model (GTM) based on the chain of graph edit operations throughout GED computation. This error traceback feature may further benefit the troubleshooting process of LLMs on mathematical modeling task.

As described herein, the method (including a system architecture) for evaluating LLMs' modeling capability of an optimization problem (e.g., LPWP) may be based on graph edit distance. The method may include a conversion of LP optimization problem into a general form of the optimization problem. In an embodiment where:

$$x = {( {x}_{1} , {x}_{2} , … {x}_{n} )}^{T} is a variables vector in {ℝ}^{n} space ,$$

$$c = {( {c}_{1} , {c}_{2} , … {c}_{n} )}^{T} is the cost vector in {ℝ}^{n} space , and$$

$$A = ( \begin{matrix}{a}_{11} & {a}_{12} & … & {a}_{1 n} \\ ⋮ & ⋮ & ⋱ & ⋮ \\ {a}_{m 1} & {a}_{m 2} & … & {a}_{mn}\end{matrix} ) is the constraints matrix in {ℝ}^{n \times m} space ,$$

an optimization (minimisation or maximisation) linear programming problem in its general form may be written as:

$$\begin{matrix}optimize \\ x ∈ {ℝ}^{n}\end{matrix} Z = {c}^{T} x = ( {\sum }_{i - 1}^{n} {c}_{i} {x}_{i} )$$

$$Subject to \{ \begin{matrix}{l}^{s} \leq Ax \leq {u}^{s} \\ {l}^{x} \leq x \leq {u}^{x}\end{matrix}$$

where c^{T}is the transpose of the cost vector, l^{s} and u^{s} are respectively the lower and upper bounds of Ax, and l^{x} and u^{x} are respectively the lower and upper bounds of x.

Further, [symbol] =R U{−∞} and [symbol] =R U{∞} are the extended real domains. l^{x} ∈ [symbol] ⁿ and u^{x} ∈ [symbol] ⁿ are lower and upper bounds for the decision variable x, and l^{s} ∈ [symbol] ^{m} and u^{s} ∈ [symbol] ^{m} are lower and upper bounds for the constraints. The type of constraints may include equality, and two-sides or one-side inequality. For one-side inequality constraints, right-side inequality may be preferred over the left-side one, by multiplying by a constant −1. Further, minimization problem may be preferred over maximization by multiplying by a constant −1.

The described general form of LP may agree with input formulation for many LP solvers including HiGHS (Huangfu, Q., & Hall, J. J. (2018). Parallelizing the dual revised simplex method. Mathematical Programming Computation, 119-142), CPLEX (ILOG, I. (2010). User's Manual for CPLEX http://www.ilog.com/.), Gurobi (Gurobi Optimization, L. (2021). Gurobi optimizer reference manual.) and other commercial solvers. In an embodiment, a robust parser may be used to extract the relevant information (e.g., objective, variables and constraints) and build the LP in general form.

Other linear programming general form(s) may also be used in converting optimization models (hypothesis and reference models) into linear programming general forms.

The method for evaluating LLMs' modeling capability on optimization problem may further include graph representation conversion. The obtained general form of linear programming of the HM and of the GTM may be converted to their corresponding graph representation. In an embodiment, the graph representation may be an attributed bipartite graph, which can be used to represent optimization problems (e.g., LP problems). The method may include obtaining a graph of the HM and a graph of the GTM. The graph of the HM has HM constraints vertices associated with HM constraints, HM variables vertices associated with HM variables, and HM edges connecting the HM constraints vertices to the HM variables vertices. The graph of the GTM has GTM constraints vertices associated with GTM constraints, GTM variables vertices associated with GTM variables, and GTM edges connecting the GTM constraints vertices to the GTM variables vertices. The method may also include transforming the graph of the HM into the graph of the GTM through a series of transformation steps. The total number of the transformation steps to transform the graph of the HM into the graph of the GTM is a measure of the accuracy of the HM. That is if the there are no transformations steps needed to transform the graph of the HM into the graph of the GTM, then both graphs are the same and the HM is accurate.

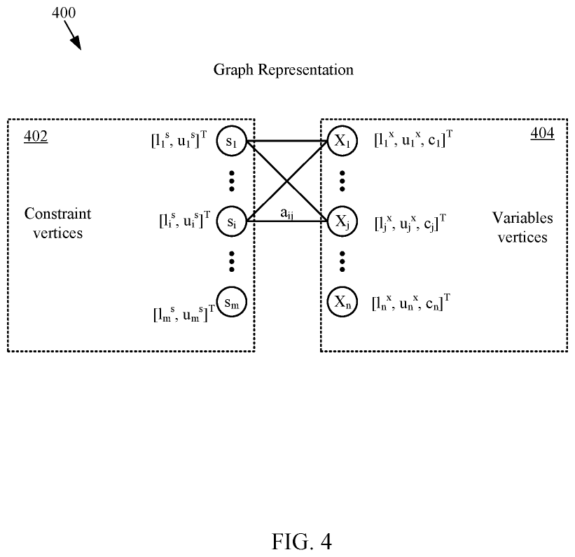

FIG. 4 shows an attributed bipartite graph G=(S U X, E) 400 may represent a linear programming problem. S is a set of constraints vertices: S={s₁, . . . sᵢ . . . sₘ}402, X is a set of variables vertices: X={X₁, . . . Xⱼ . . . Xₙ}404, and E is a set of edges connecting constraints vertices to variables vertices. Vertices s₁ and Xᵢ corresponds to the j-th constraints vector and the i-th variables vector respectively. The graph topology is determined by the constraints matrix A. The information contained in c, A, l^{x}, l^{u}, l^{s}, and l^{u} may be represented as vertices and edges attributes as described in relation to the embodiments shown herein.

The set of constraints vertices S and the set of variables vertices X may be disjoint sets. The set of constraints vertices S 402 may correspond to the set of constraints in the optimization problem (e.g., LPWP). The set of variables vertices X 404 may correspond to the set of variables (decision variables) in the optimization problem. Vertex sᵢ, in the set of constraints vertices, may correspond to the pair [lᵢ^{s},uᵢ^{s}] that defines the i-th constraint where:

$${l}_{i}^{s} \leq ( {a}_{i 1} , {a}_{i 2} , … , {a}_{i n} ) ( \begin{matrix}{x}_{1} \\ {x}_{2} \\ … \\ {x}_{n}\end{matrix} ) \leq {u}_{i}^{s} .$$

The notation Xⱼ, in the set of variables vertices, may be overloaded to represent the one or more variables attributes that may include a lower bound lⱼ^{x}, an upper bound uⱼ^{x} and an objective coefficient cⱼ: [iⱼ^{x},uⱼ^{x},cⱼ]^{T} where:

lⱼ^{x}≤xⱼ≤uⱼ^{x}.

The topology of the attributed bipartite graph G 400 may be determined by the constraints matrix A in that the set of edges E={E(sᵢ, xⱼ)}connecting vertex sᵢ with vertex Xᵢ exists if and only if Aᵢⱼ≅0. The attribute of this edge may be defined by the constraints matrix element aᵢⱼ.

An advantage of representing the general form of LP as an attributed bipartite graph is the intrinsic permutation invariance of the variables and the permutation invariance of the constraints. This refers to the equivalence of two models (e.g., a HM and its corresponding reference model) even though the order of one or more elements may be changed (e.g., one or more of decision variables, cost vector, bound vectors, and columns in the constraints matrix are permuted). Accordingly, the method may not be affected by changes in the order of relevant elements or items. Following this bipartite graph representation, for any optimization model of a LP word problem (P) in general form, it can be transformed into an attributed bipartite graph, i.e., (P)→G=(S U X, E).

The method for evaluating LLMs' modeling capability on optimization problem may further include a graph edit distance (GED) calculation. In some embodiments, GED may be defined by the minimum-cost sequence of basic edit operations to transform one graph into another. The basic edit operations may relate to one or more of: vertices and edges. The basic edit operations may include one or more of: insertion, deletion and substitution. For generality, all these operations may be called matching, e.g., deleting vertex can be viewed as matching this vertex to empty vertex E.

A GED may be calculated using various techniques. Any appropriate technique (including well-established methods) can be adopted once the cost of each matching operation is defined. In some embodiments, the cost of each matching operation may be defined based on a principle, i.e., the operation of each number in the hypothesis graph requires 1 unit cost. For example, given the hypothesis graph G^{h}=(S^{h} U X^{h}, E^{h}) and the reference graph G^{r}=(S^{r} U X^{r}, E^{r}), the cost of substituting constraints vertex sᵢ^{h} to sᵢ^{r} is the number of mismatched attributes (#msm) between the two constraints vertices, i.e., Cᵥ(sᵢ^{h}→s_{i′}^{r})=#msm(sᵢ^{h},s_{i′}^{r}). The same cost approach used for substituting a constraints vertex can be used for substituting a variables vertex. The cost of deleting a constraints variables vertex sᵢ^{r} may be based on the number of its attributes, i.e., Cᵥ(sᵢ^{h}→ε)=#attr(sᵢ^{r}). Similarly, the cost of inserting a vertex may be equivalent to matching an empty vertex E with the inserted vertex.

Using any appropriate method for computing the GED, the GED between a hypothesis graph and a reference graph may be obtained. In some embodiments, this distance metric may be normalized to graph size. A larger hypothesis LP problem with a larger graph tends to make more mistake and increase its edit distance to the corresponding reference graph. In such embodiments, a relative distance with respect to the size of graphs may be used. Thus, in some embodiments, the method for evaluating LLMs' modeling capability on optimization problem may further include normalizing the edit distance by the size of the graph.

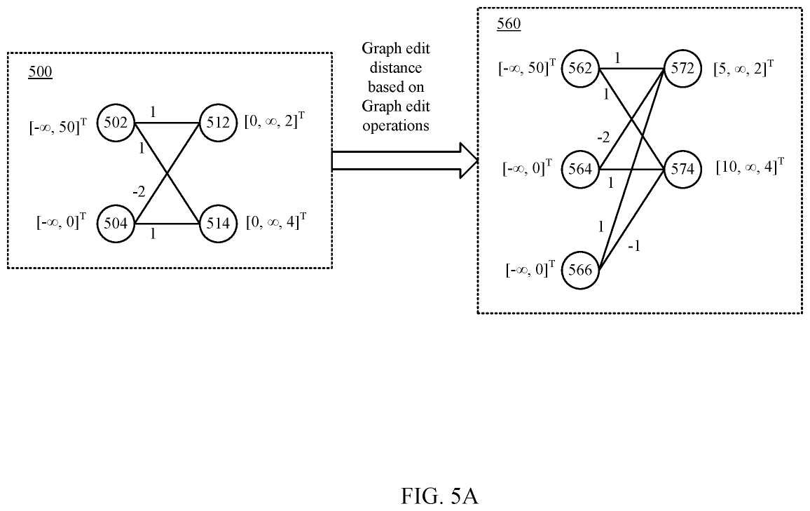

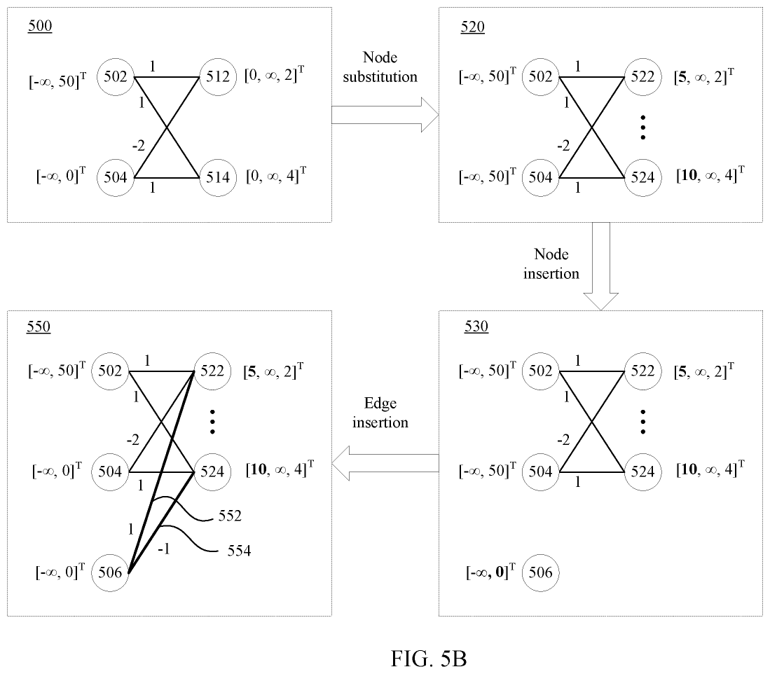

FIGS. 5A and 5B illustrate an example of a graph edit path from a HM graph to a GTM graph, according to an embodiment. Graph 500, being an attributed bipartite graph, is the HM graph that represents the prediction 306 of FIG. 3. Graph 500 may include a first set of vertices including 502 and 504 representing or corresponding to the constraints of the prediction 306. The first vertex 502 may correspond to the first constraint: x₁+x₂<=50 of the prediction 306 (l₁^{s}=−∞,u₁^{s}=50). The attributes, [−∞, 50]^{T}, of the first constraint vertex 502 may include a lower bound of −∞ and an upper bound of 50. The second vertex 504 may correspond to the second constraint: x₂<=2x₁, which may be rewritten as −2x₁+x₂<=0 (l₂^{s}=−∞, u₂^{s}=0). For the second constraint vertex 504, its attributes, [−∞, 0]^{T}, include a lower bound of −∞ and an upper bound of 0. In the present embodiment, HM graph is based on the HM, which based on the output of a LLM to which a LPWP has been provided. The LPWP may be a math word optimization problem. The LLM may output the HM variables, a lower bound for each respective HM variable of the HM variables, and an upper bound for each respective HM variable of the HM variables. The LLM may also output at least one HM function that depends on the HM variables. The at least one function may a quantity to be optimized in accordance with the math word problem. The LLM may further output one or more HM constraints equation, which define the HM constraints placed on the HM variables. Obtaining the graph of the HM may include forming a HM attributed bipartite graph by generating the HM constraints vertices (which depend on the HM variables and the one or more HM constraints equation), the HM variables vertices (which depend on the HM variables, on the lower bound and the upper bound for each respective HM variable of the HM variables, and on the at least one HM function), and the HM edges that connect the HM constraints vertices to the HM variables vertices. The HM constraints vertices form a first set of HM vertices that is disjoint from a second HM set of vertices formed from by the HM variables vertices. Obtaining the graph of the GTM is, mutatis mutandis, similar to obtaining the HM graph.

Graph 500 may further include a second set of vertices 512 and 514 respectively associated with the variables x₁ and x₂ of the prediction 306. The attributes of the vertex 512 may be based on the lower bound l₁^{x} of x₁, the upper bound u₁^{x} of x₁, and the coefficient of the x₁ component, c₁, of the function to optimize (Z=2x₁+4x₂). According to the prediction 306 indicating x₁>=0, the lower bound of x₁ is zero and the upper bound is ∞. According to the equation to be maximized, c₁ is 2. As such, the attributes of the vertex 512 are l₁^{x}=0,u₁^{x}=∞, c₁=2. The vertex 512 may be represented in vector form as [0, ∞, 2]^{T}.

The attributes of the vertex 514 may be based on the lower bound l₂ of x₂, the upper bound of u₂^{x} of x₂, and the coefficient of the x₂ component, c₂, of the function to optimize (Z=2x₁+4x₂). According to the prediction 306 indicating x₂>=0, the lower bound of x₂ is zero and the upper bound of x₂ is ∞. According to the equation to be maximized, c₂ is 4. As such, the attributes of the vertex 514 are l₂^{x}=0,u₂^{x}=∞, c₂=4. The vertex 514 may be represented in vector form as [0, ∞, 4]T

The value of the edges between the vertices may be determined in accordance with the constraints equation, the general form of which is:

$${l}_{i}^{s} \leq ( {a}_{i 1} , {a}_{i 2} , … , {a}_{i n} ) ( \begin{matrix}{x}_{1} \\ {x}_{2} \\ … \\ {x}_{n}\end{matrix} ) \leq {u}_{i}^{s} ,$$

which yields:

$$- ∞ \leq ( 1 , 1 ) ( \begin{matrix}{x}_{1} \\ {x}_{2}\end{matrix} ) \leq 50 first constraint graph 500 , and$$

$$- ∞ \leq ( - 2 , 1 ) ( \begin{matrix}{x}_{1} \\ {x}_{2}\end{matrix} ) \leq 0 second constraint graph 500.$$

The edge connecting constraints vertex 502 with variables vertex 512 may have a weight of 1 based on the first constraint. Similarly, the edge connecting constraints vertex 502 with variables vertex 514 may have a weight of 1 based on the first constraint. The edge connecting constraints vertex 504 with variables vertex 512 may have a weight of −2 based on the second constraint. Similarly, the edge connecting constraints vertex 504 with variables vertex 514 may have a weight of 1 based on the second constraint.

Graph 560, which is also an attributed bipartite graph, may represent the reference or GTM 304 of FIG. 3. Graph 560 may include a first set of vertices including 562, 564 and 566 representing or corresponding to the constraints of the ground truth 304. The vertex 562 may be based on a first constraint: x₁+x₂<=50 of the ground truth 304 (l₁^{s}=−∞,u₁^{s}=50). The attributes of the constraints vertex 562 may include a lower bound of −∞ and an upper bound of 50. The vertex 562 may be represented in vector form as [−∞, 50]^{T}. The GTM may be obtained from any reliable source of LPWP such as, for example, LPWP textbooks. The GTM may also be based on an analysis of the LPWP by a LPWP expert. The GTM may have a lower bound and an upper bound for each respective GTM variable. The GTM may also have at least one GTM function depending on the GTM variables. The at least one GTM function may define an output to be optimized in accordance with the math word problem. The GTM may further have one or more GTM constraints equation that define GTM constraints placed on the GTM variables.

The vertex 564 may be based on the second constraint: x₂<=2x₁ of the ground truth 304. The second constraint x_{2<=2}x₁ can be rewritten as −2x₁+x₂<=0 (l₂^{s}=−∞,u₂^{s}=0). The attributes of the constraints vertex 564 may include a lower bound −∞ and an upper bound 0. The vertex 564 may be represented in vector form as [−∞, 0]^{T}.

The vertex 566 may be based on a third constraint: x₁<=x₂, which can be rewritten as x₁−x₂<=0 (l₃^{s}=−∞,u₃^{s}=0). The attributes of the constraints vertex 566 may include a lower bound of −∞ and an upper bound of 0. The vertex 566 may be represented in vector form as [−∞, 0]^{T}.

Graph 560 may further include a set of variables vertices 572 and 574 corresponding to, respectively, the decision variables x₁ and x₂ of the ground truth 304. The attributes of the vertex 572 may be based on the lower bound l₁^{x} of x₁, the upper bound u₁^{x} of x₁, and the coefficient of the x₁ component, c₁, of the function to optimize (Z=2x₁+4x₂). According to the prediction 304 indicating x₁>=5, the lower bound of x₁ is 5 and the upper bound is ∞. According to the equation to be maximized, c₁ is 2. As such, the attributes of the vertex 512 are l₁^{x}=5, u₁^{x}=∞, c₁=2. The vertex 572 may be represented in vector form as [5, ∞, 2]^{T}.

The attributes of the vertex 574 may be based on the lower bound l₂^{x} of x₂, the upper bound of u₂^{x} of x₂, and the coefficient of the x₂ component, c₂, of the function to optimize (Z=2x₁+4x₂). According to the prediction 304 indicating x₂>=10, the lower bound of x₂ is 10 and the upper bound of x₂ is ∞. According to the equation to be maximized, c₂ is 4. As such, the attributes of the vertex 574 are 12=10, u₂^{x}=∞, c₂=4. The vertex 514 may be represented in vector form as [0, ∞, 4]^{T}.

The value of the edges between the vertices of the graph 560 may be determined in accordance with the constraints equation, the general form of which is:

$${l}_{i}^{s} \leq ( {a}_{i 1} , {a}_{i 2} , … , {a}_{i n} ) ( \begin{matrix}{x}_{1} \\ {x}_{2} \\ … \\ {x}_{n}\end{matrix} ) \leq {u}_{i}^{s} ,$$

which yields:

$$- ∞ \leq ( 1 , 1 ) ( \begin{matrix}{x}_{1} \\ {x}_{2}\end{matrix} ) \leq 50 first constraint graph 560 ,$$

$$- ∞ \leq ( - 2 , 1 ) ( \begin{matrix}{x}_{1} \\ {x}_{2}\end{matrix} ) \leq 0 second constraint graph 560 , and$$

$$- ∞ \leq ( 1 , - 1 ) ( \begin{matrix}{x}_{1} \\ {x}_{2}\end{matrix} ) \leq 0 third constraint graph 560.$$

The edge connecting constraints vertex 562 with variables vertex 572 may have a weight of 1 based on the first constraint. Similarly, the edge connecting constraints vertex 562 with variables vertex 574 may have a weight of 1 based on the first constraint. The edge connecting constraints vertex 564 with variables vertex 572 may have a weight of −2 based on the second constraint. Similarly, the edge connecting constraints vertex 564 with variables vertex 574 may have a weight of 1 based on the second constraint. The edge connecting constraints vertex 566 with variables vertex 572 may have a weight of 1 based on the third constraint. Similarly, the edge connecting constraints vertex 566 with variables vertex 574 may have a weight of −1 based on the third constraint.

Determining the graph edit path (a minimum sequence of edit operations) from the hypothesis graph 500 to the reference graph 560 may involve one or more edit operations as illustrated in FIG. 5B. In an embodiment, graph 500 may be edited via one or more edit operations, to obtain graph 520. For example, variables vertex 512 having attributes [0, ∞, 2]^{T} may be substituted with variables vertex 522 having attributes [5, ∞, 2]^{T}, where variables vertex 522 is equivalent to variables vertex 572 of the reference graph 560. In an embodiment, the cost of this vertex substitution may be based on the count of attribute changes. For example, substituting variables vertex 512 with variables vertex 522 involves changing the lower bound attribute 0 of variables vertex 514 to the lower bound attribute 5 of variables vertex 522. The cost of this change may be 1 unit cost based on 1 count of attribute change.

A second edit operation may involve substituting variables vertex 514 having attributes [0, ∞, 4]^{T} with variables vertex 524 having attributes [10, ∞, 4]^{T}, where variables vertex 524 is equivalent to variables vertex 574 of the reference graph 560. In an embodiment, the cost of this vertex substitution involves changing the lower bound attribute 0 of variables vertex 514 to the lower bound attribute 10 of variables vertex 524. The cost of this change may be 1 unit cost based on 1 count of attribute change.

Accordingly, two edit operations corresponding to 2 unit costs are required to change graph 500 to graph 520. A next set of edit operations, based on the reference graph 560, may involve inserting the constraints vertex 506 to the graph 520 to obtain graph 530. The constraints vertex 506 may be based on and correspond to the constraints vertex 566 of the reference graph 560. The constraints vertex 506 may have the same attributes, [−∞, 0]^{T}, as those of constraints vertex 566. In an embodiment, the cost of inserting the constraints vertex 506 may be based on the number of attributes of the vertex. The cost of inserting constraints vertex 506 may be 2 units based on the two attributes, lower bound −∞ and upper bound 0.

Accordingly, one edit operation (vertex insertion) corresponding to 2 unit costs is required to change graph 520 to graph 530, and a total of 4 unit costs for changing or transforming graph 500 to graph 530. Any suitable algorithm may be used to automatically transform a HM graph into a GTM graph. Examples of such algorithms include a graph edit distance computing algorithm, an A* algorithm, and a depth-first graph edit distance algorithm.

According to an embodiment, a next set of edit operations, based on the reference graph 560, may involve inserting edges 552 and 554 to change graph 530 to graph 550, which, in the present example, is equivalent to graph 560. As described herein, the constraint vertex 506 corresponds to the constrain vertex 566 of the reference graph 560. To arrive at the reference graph 560, edges 552 and 554 are added. According to an embodiment, the cost of inserting an edge may be 1 unit cost. Accordingly, the cost of inserting edges 552 and 554 may be 2 unit costs. The total unit cost, therefore, for transforming the hypothesis graph 510 to the reference graph 560 is 6 unit costs corresponding to two vertex substitutions to obtain graph 520, a vertex insertion to obtain graph 530 and two edge insertions to obtain graph 550, which is equivalent to the reference graph 560.

Determining the one or more edit operations (or transformation steps) in transforming graph 500 to graph 550 may indicate the errors made by the LLM that generated the prediction (HM) 306. According to an aspect, an error traceback feature may be provided that allows for identifying one or more mismatches between the HM and the reference model based on the chain of graph edit operations. The one or more mismatches may refer to the one or more edit operations (or transformation steps) for transforming the HM to the reference model. The transformation steps may include a substitution of a HM constraints value with a different HM constraints value, a substitution of a HM variables value with a different HM variables value, an addition of a HM constraints vertex, an addition of a HM variables vertex, a deletion of a HM constraints vertex, a deletion of a HM variables vertex, an addition of an edge connecting an HM constraints vertex to an HM variables vertex, a deletion of a second edge connecting a second HM constraints vertex to a second HM variables vertex, and a substitution of a weight of any edge with a different weight.

According to an aspect, the one or more methods described herein may be implemented or incorporated into a platform as a service to evaluate the model building capability of the Operations Research (OR) products with LLMs as their fundamental component. Validation of model-building proficiency prior to the official release of these products is important in order to ensure optimal performance and maintain competitive advantage of the product to release. In an embodiment, the input of this service may be in the form of mathematical formulation of LPs, e.g., the optimization model 104 in FIG. 1. In some embodiments, the service may narrowly accept a certain format of mathematical formulation of a model (e.g., the optimization model 104) as input.

In some embodiments, the output of the service may be a single numerical score indicating how similar the single-model input is to its ground truth. In some embodiments, the output of the service may be an accuracy score indicating an overall performance of the LP modeling product on the complete testing corpus. In some embodiments, the output may include the details (e.g., edit operations) on one or more errors or mistakes (e.g., a sequence or chain of mistakes) in the model built by the product based on the error traceback feature. In some embodiments, the output may include a suggestion of how to fix the problematic model built by the product.

According to an aspect, a testing and analysis tool for a linear programming automatic modeling product may be provided. In an embodiment, a testing corpus (equipped with LP problems and their ground truth mathematical model formulations) may be used to evaluate an LP modeling product that has already built model formulations for all problems in the testing corpus. Each problem in the testing corpus may have a HM and a reference model.

In an embodiment, the complete corpus may be used to evaluate the LP modeling product based on one or more methods described herein. For example, the method may include obtaining a set of general forms of LPs of the model formulations produced by the LP modeling product. The method may further include converting the set of general forms of the LPs into graph representations, such as attributed bipartite graphs. The method may be further include obtaining a set of GEDs based on the graph representations corresponding to the model formulations and graph representations of the reference models. In some embodiments, the testing and analysis tool may analyze and return result statistics including one or more of: a ratio of exact matches (the ratio of graph edit distance=0), a mean of normalized graph edit distance, and a ratio of HM with normalized graph edit distance in a certain threshold (which can be determined by a user).

In some embodiments, the testing and analysis tool may evaluate the LP modeling product based on a single problem. Accordingly, the method may be based on a single HM generated by the LP modeling product and the corresponding reference model. In such embodiments, the testing and analysis tool may return one or more of: a graph edit distance, a chain of graph edit operations recorded based on computing the graph edit distance.

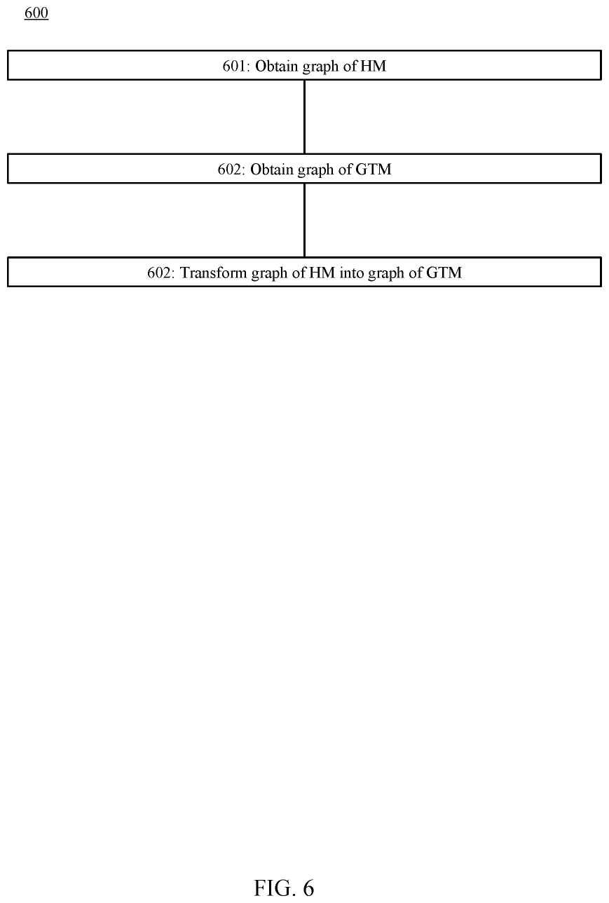

FIG. 6 illustrates a flowchart of an embodiment of a method 600 according to the present disclosure. The method 600 may be used to evaluate an LLMs' modeling capability on optimization problem by evaluating a HM generated by the LLM against a GTM. The method 600 includes, at action 601, obtaining a graph of the HM and, at action 602, obtaining a graph of the GTM. The graph of the HM has HM constraints vertices associated with HM constraints, HM variables vertices associated with HM variables, and HM edges connecting the HM constraints vertices to the HM variables vertices. The graph of the GTM has GTM constraints vertices associated with GTM constraints, GTM variables vertices associated with GTM variables, and GTM edges connecting the GTM constraints vertices to the GTM variables vertices. The method may also include, at action 603, transforming the graph of the HM into the graph of the GTM through a series of transformation steps. The total number of transformation steps to transform the graph of the HM into the graph of the GTM is a measure of the accuracy of the HM. That is if the there are no transformations steps needed to transform the graph of the HM into the graph of the GTM, then both graphs are the same and the HM is accurate.

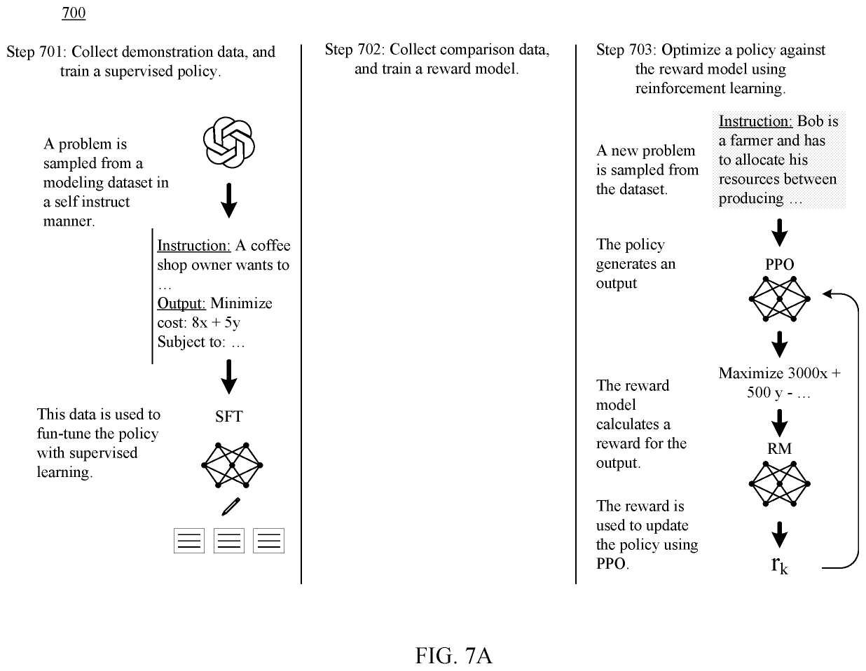

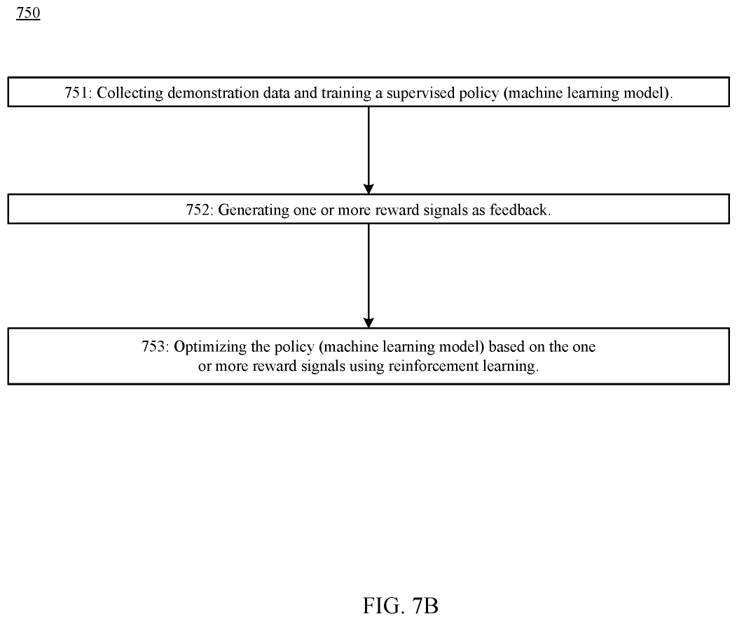

According to an aspect, a reward function may be encoded in a procedure of reinforcement learning from human feedback (RLHF). FIG. 7A illustrates a flow of an embodiment of method for reinforcement learning from human feedback in accordance with the present disclosure. Method 700 is based on a machine learning approach that combines reinforcement learning techniques with human feedback to train or fine-tune machine learning models. RLHF is a technique that trains a “reward model” directly from human feedback and uses the model as a reward function to optimize an agent's policy (e.g., a LLM) using reinforcement learning (RL) through an optimization method. The reward model is trained in advance to the policy (machine learning model) being optimized to predict if a given output is good (high reward) or bad (low reward). RLHF can improve the robustness and exploration of RL agents. RLHF includes, at step 701, collecting demonstration data and training a supervised policy. This step involves generating a set of modeling problem data in a self instruct manner. The data is used to fine-tune the policy (the machine learning model) with supervised learning. The RLHF further includes, at step 702, collecting comparison data and training a reward model. Comparison data at step 702 is based on human feedback, which is used to construct the reward model.

The RLHF further includes, at step 703, optimizing the policy (machine language model) against the reward model using reinforcement learning. This step involves sampling a new problem from the data set and generating an output by the policy. The reward model may then calculate a reward for the output. The reward is used to update the policy using a reinforcement learning method such as proximal policy optimization (PPO).

The RLHF is based on training the reward model, at step 702, which relies on large-scale real human feedback usually in the form of manually labeled text ranking. This labeling process is time-consuming and labor-intensive. According to an embodiment, the reward model generated at step 702 of the RLHF 700 may be replaced by a reward function operating based on one or more methods described herein. As a result, an improved method of training an LLM may be provided for linear programming modeling based on reinforcement learning. As will be understood by the skilled worker, other approaches, such as those described in the article by Long Ouyang et al.; “Training language models to follow instructions with human feedback”, 36th Conference on Neural Information Processing Systems (NeurIPS 2022), may be adapted by replacing the human feedback aspect with embodiments of the present disclosure.

FIG. 7B illustrates a method for training a machine learning model based on reinforcement learning, according to an embodiment. Method 750 includes, at 751, collecting demonstration data and training a supervised policy (e.g., machine learning model). The collection of demonstration data and training the supervised policy 751 may be similar to collection of demonstration data and training the supervised policy of step 701 of RLHF method 700.

Method 750 may further include generating 752 one or more reward signals as feedback. In some embodiments, generating one or more reward signals may be based on method 600. For example, method 600 may be operated by a reward function to generate one or more reward signals as feedback for reinforcement learning. In an embodiment, generating one or more reward signals may include obtaining a graph representation (e.g., attributed bipartite graph) of a prediction or HM of the machine learning model. The HM may be based on an optimization problem (e.g., LPWP) that is fed to the machine learning model. Generating one or more reward signals may further include obtaining a graph representation (e.g., an attributed bipartite graph) of the GTM or reference model corresponding to the optimization problem. Generating one or more reward signals may further include obtaining a reward signal indicating a quality of the HM. Obtaining the reward signal may include obtaining a set of edit operations (or transformation steps) to transform the graph representation of the HM to the graph representation of the reference model. Generating one or more signals may obviate the need for human feedback as may be required in RLHF. Accordingly, the feedback aspect of method 750 may be performed automatically without the need for human feedback.

Method 750 may further include optimizing 753 the policy (e.g., the machine learning model) based on the one or more reward signals using reinforcement learning.

As described herein, method 750 may allow for replacing the human feedback reward (step 702) with the one or more reward signals generated 752 to train an LLM. In some embodiments, method 750 may be used to train an LLM for task-specific modeling e.g., linear programming modeling, in a reinforcement feedback manner.

In some embodiments, the total number of transformation steps for transforming a graph of a HM generated by a LLM into a graph of a GTM may be used for determining an accuracy score of the LLM and also to modify the LLM according to know techniques. When the LLM is modified, a further HM of the LPWP may be generated by the modified LLM and a graph of the further HM may be transformed into the GTM in a further number of transformation steps. In other embodiments, the modified LLM may be used to generate a further HM of a different LPWP to which is associated a respective GTM. The transformation of a graph of the further HM into the graph of the respective GTM may be proceed and a new accuracy score may be obtained. This iterative process may be repeated until a stop criterion is met. The stop criterion may be based on a preset accuracy value (e.g., HM is accurate more than a preset percentage value (e.g., 99%)), on a preset maximum number of iterations, a preset maximum runtime value, or on any other suitable stop criterion).

According to an aspect, troubleshooting process may be improved by improved detection of the categories of mistakes produced by LLMs. For example, the troubleshooting process may be sped up by fast detection of the categories of mistakes produced by LLMs.

Existing evaluation metrics (e.g., execution and canonical metrics) may only determine how many samples in a testing data are correct or incorrect. These metrics don't offer insights into the specific issues that a current version of an LLM frequently encounters. It's possible that the LLM performs exceptionally well on most test cases but struggles with specific patterns. In the past, manual inspection was needed to review all incorrect cases, categorizing them based on their similarities—a process termed as “troubleshooting”.

According to an aspect, the error traceback feature described herein may allow for identifying errors (including recurring errors) that an LLM makes in generating HMs. The error traceback feature may further allow for automatic detection of these errors or problems. Identifying these errors may allow for using data augmentation strategies and generating more of these challenging samples to fine-tune the LLM further. By exposing the LLM to an increased volume of these data points and their corresponding correct models, LLM's performance for these specific challenges can be enhanced.

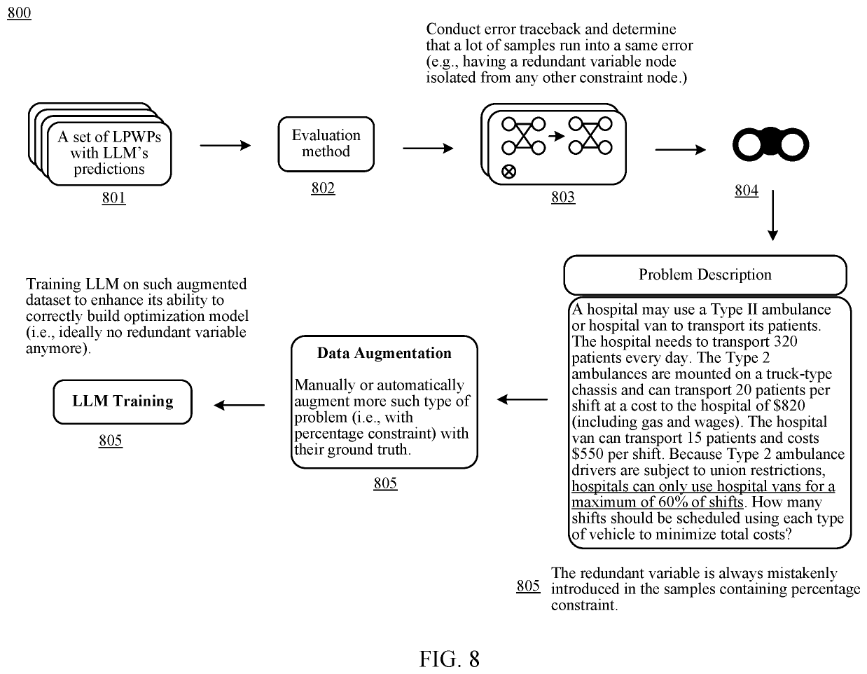

FIG. 8 illustrates a flow of an embodiment of a method of training a LLM based on error traceback, according to the present disclosure. Method 800 includes evaluating, using an evaluation method 802, a set of LPWPs with an LLM's predictions 801 to obtain one or more errors 803 in the predictions. In some embodiments, the evaluation method 802 may refer to conducting error traceback to determine one or more errors in the LLM's prediction. In some embodiments, the evaluation method 802 may be similar to method 600. For example, evaluation method 802 may include obtaining graph representations (e.g., attributed bipartite graphs) of the LLM's prediction. The evaluation method 802 may further include obtaining graph representations (e.g., attributed bipartite graphs) of GTMs or reference models corresponding to the set of LPWPs. The evaluation method 802 may further include obtaining a set of edit operations (or transformation steps) to transform the graph representations of the predictions to the graph representation of the reference models. The transformation steps may indicate the one or more errors in the LLM's predictions. For example, evaluation method 802, via the error traceback feature, may identify that numerous problematic samples yield the same “redundant variable” error isolated from any other constraints vertex 803. Method 800 may further include generating a training dataset based on identified one or more errors. In some embodiments, generating a training dataset may include identifying common patterns 805 in the problematic samples. The common pattern may be that the redundant variable is always mistakenly introduced in the samples containing percentage constraint. In some embodiments, the identification of common patterns 805 in the problematic samples may be automatic, and any appropriate method may be used to identify the common pattern among the problematic samples. In some embodiments, a human reviewer 804 may examine the problematic samples and discern their shared or common patterns.

After recognizing the common pattern (e.g., percentage constraint) among the problematic samples, generating the training dataset may further include employing one or more data augmentation techniques to generate more of these samples. Employing one or more data augmentation techniques may involve manually or automatically augmenting more of such types of problems (i.e., with percentage constraint) with their ground truths. Method 800 may further include training LLM 806 on the generated training dataset or augmented dataset. Training LLM on the generated training dataset may enable the LLM to better manage such scenarios.

According to one or more aspects, systems, methods and apparatus for an evaluation strategy grounded on graph edit distance may be provided for assessing the capability of LLMs on auto-formulating optimization model.

The systems, methods and apparatus described herein may allow for a more accurate and robust evaluation method for auto-formulating optimization modeling with LLMs, addressing pitfalls of prior approaches through permutation invariance and better identification of model exact match.

In some embodiments, available information in other modalities, such as textual explanations, may be integrated into one or more methods, systems, and apparatus described herein. For example, referring to FIG. 1, optimization model 104, each model component (declaration) is followed by its explanation generated by LLM. Such textual explanations may be added as another attribute to their corresponding vertex in the attributed bipartite graph of the optimization model. A cost function may be further defined for this added attribute and included in the evaluation metric described in one or more aspects herein. Integrating available information in other modalities can potentially allow for a more fine-grained evaluation metric and be further aligned with human's perspective.

In some embodiments, based on the error traceback feature described herein, one or more errors of the prediction models may be obtained. While in some embodiments, a score may be obtained that indicates the degree of difference between optimization models, in other embodiments, one or more mismatches or errors (including where such mismatches occur) may be obtained based on a chain of graph edit operations throughout the GED computing. This feature of identifying one or more errors can further benefit the troubleshooting process of LLM training as described herein.

While some embodiments are described in reference to LPWP, the methods, systems, and apparatus described herein may extend to other types of optimization problems that can be represented as graphs. Other types of optimization problems may include mixed integer linear programming (MILP), quadratic programming (QP), and quadratically constrained quadratic programming.

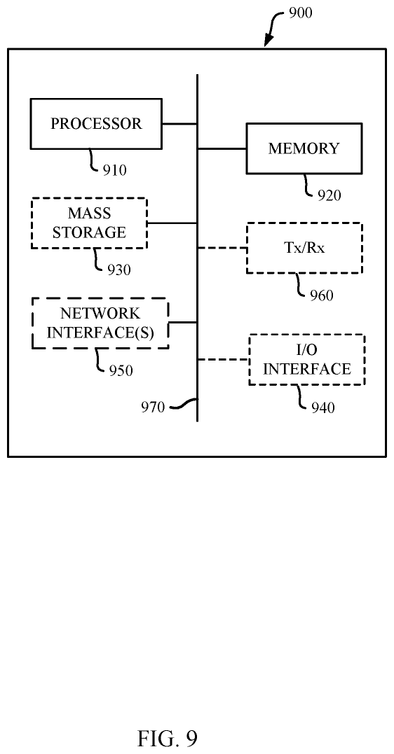

In accordance with the present disclosure, FIG. 9 illustrates an embodiment of apparatus 900 that may perform any or all of operations of the above methods and features explicitly or implicitly described herein, according to different aspects of the present disclosure. For example, a computer equipped with network function may be configured as the apparatus 900. In some aspect, apparatus 900 can be a device that connects to the network infrastructure over a radio interface, such as a mobile phone, smart phone or other such device that may be classified as user equipment (UE). In some aspects, the apparatus 900 may be a Machine Type Communications (MTC) device (also referred to as a machine-to-machine (m2m) device), or another such device that may be categorized as a UE despite not providing a direct service to a user. In some aspects, apparatus 900 may be used to implement one or more methods, operations, components, systems, mechanisms according to one or more aspects described herein.

As shown in FIG. 9, the apparatus 900 may include a processor 910, such as a Central Processing Unit (CPU) or specialized processors such as a Graphics Processing Unit (GPU) or other such processor unit, memory 920, non-transitory mass storage 930, input-output interface 940, network interface 950, and a transceiver 960, all of which are communicatively coupled via bi-directional bus 970. Transceiver 960 may include one or multiple antennas According to certain aspects, any or all of the depicted elements may be utilized, or only a subset of the elements. Further, apparatus 900 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, a magnetic disk drive, an optical disk drive, USB drive, or any computer program product configured to store data and machine executable program code. According to certain aspects, the memory 920 or mass storage 930 may have recorded thereon statements and instructions executable by the processor 910 for performing any method operations described herein.

The processor 910 and memory 920 may function together as a chipset which may be provided together for installation into wireless communication apparatus 900 in order to implement WLAN functionality. The chipset may be configured to receive as input data including but not limited to PPDUs from the network interface 950. The chipset may be configured to output data including but not limited to PPDUs to the network interface 950.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although a combination of features is shown in the illustrated embodiments, not all of them need to be combined to realize the benefits of various embodiments of this disclosure. In other words, a system or method designed according to an embodiment of this disclosure will not necessarily include all features shown in any one of the Figures or all portions schematically shown in the Figures. Moreover, selected features of one example embodiment may be combined with selected features of other example embodiments.

The word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context. The term “and/or” herein when used in association with a list of items means any one or more of the items comprising that list.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A computer-implemented method for evaluating an accuracy of a hypothesis model (HM) against a ground truth model (GTM), the method comprising:
obtaining a graph of the HM, the graph of the HM containing HM constraints vertices associated with HM constraints, HM variables vertices associated with HM variables, and HM edges connecting the HM constraints vertices to the HM variables vertices;
obtaining a graph of the GTM, the graph of the GTM containing GTM constraints vertices associated with GTM constraints, GTM variables vertices associated with GTM variables, and GTM edges connecting the GTM constraints vertices to the GTM variables vertices; and
transforming the graph of the HM into the graph of the GTM through a series of transformation steps, a total number of the transformation steps to transform the graph of the HM into the graph of the GTM being a measure of the accuracy of the HM.

2. The computer-implemented method of claim 1, wherein transforming the graph of the HM into the graph of the GTM includes automatically transforming the graph of the HM into the graph of the GTM using a graph edit distance computing algorithm.

3. The computer-implemented method of claim 1, further comprising obtaining the HM by inputting a math word problem into a large language model (LLM) to generate the HM.

4. The computer-implemented method of claim 3, wherein inputting the math word problem into the LLM includes inputting a math word optimization problem into the LLM.

5. The computer-implemented method of claim 3, wherein generating the HM comprises:
obtaining, from the LLM:
the HM variables;
a lower bound for each respective HM variable of the HM variables; and
an upper bound for each respective HM variable of the HM variables;
at least one HM function depending on the HM variables, the at least one function defining an output to be optimized in accordance with the math word problem; and
one or more HM constraints equation, the one or more HM constraints equation defining the HM constraints placed on the HM variables; and
transforming the at least one HM function and the one or more HM constraints equation into a general linear programming model of the math word problem to obtain the HM.

6. The computer-implemented method of claim 5, wherein the GTM model has associated thereto:
a lower bound and an upper bound for each respective GTM variable of the GTM variables;
at least one GTM function depending on the GTM variables, the at least one GTM function defining an output to be optimized in accordance with the math word problem; and
one or more GTM constraints equation, the one or more GTM constraints equation defining the GTM constraints placed on the GTM variables.

7. The computer-implemented method of claim 6, wherein:
obtaining the graph of the HM includes forming a HM attributed bipartite graph by generating:
the HM constraints vertices in accordance with:
the HM variables; and
the one or more HM constraints equation;
the HM variables vertices in accordance with:
the HM variables;
the lower bound and the upper bound for each respective HM variable of the HM variables; and
the at least one HM function;
and
the HM edges connecting the HM constraints vertices to the HM variables vertices in accordance with the one or more HM constraints equation, wherein:
the HM constraints vertices form a first HM set of vertices,
the HM variables vertices form a second HM set of vertices,
the first HM set of vertices and the second HM set of vertices are disjoint,
and
obtaining the graph of the GTM includes forming a GTM attributed bipartite graph by generating:
the GTM constraints vertices in accordance with:
the GTM variables; and
the one or more GTM constraints equation;
the GTM variables vertices in accordance with:
the GTM variables;
the lower bound and the upper bound for each respective GTM variable of the GTM variables; and
the at least one GTM function;
and
the GTM edges connecting the GTM constraints vertices to the GTM variables vertices in accordance with the one or more GTM constraints equation, wherein:
the GTM constraints vertices form a first GTM set of vertices,
the GTM variables vertices form a second GTM set of vertices, and
the first GTM set of vertices and the second GTM set of vertices are disjoint.

8. The computer-implemented method of claim 1, wherein:
the HM constraints vertices have associated thereto HM constraints values,
the HM variables vertices have associated thereto HM variables values, and
the series of transformation steps includes at least one of:
a substitution of a HM constraints value with a different HM constraints value;
a substitution of a HM variables value with a different HM variables value;
an addition of a HM constraints vertex;
an addition of a HM variables vertex;
a deletion of a HM constraints vertex;
a deletion of a HM variables vertex;
an addition of an edge connecting an HM constraints vertex to an HM variables vertex;
a deletion of a second edge connecting a second HM constraints vertex to a second HM variables vertex; and
a substitution of a weight of any edge with a different weight.

9. The computer-implemented method of claim 3, further comprising:
obtaining an accuracy score in accordance with the total number of transformation steps, the accuracy score indicating the ability of the LLM to generate accurately the HM;
modifying the LLM in accordance with the accuracy score; and
iteratively performing actions A) through G) until a stop criteria is met, the actions A) to G) being as follows:
A) generating a further HM by inputting a further math word problem into the LLM, the further math word problem having associated thereto a further GTM;
B) obtaining a graph of the further HM;
C) obtaining a graph of the further GTM;
D) transforming the graph of the further HM into the graph of the further GTM through a series of further transformation steps, a total number of the further transformation steps to transform the graph of the further HM into the graph of the further GTM being a measure of the accuracy of the further HM;
E) obtaining a further accuracy score in accordance with the total number of the further transformation steps, the further accuracy score indicating the ability of the LLM to generate accurately the further HM;
F) modifying the LLM in accordance with the accuracy score;
G) determining if the stop criteria is met.

10. The computer-implemented method of claim 5, wherein:
obtaining a first graph representation comprises: obtaining a first set of graph representations of a first set of optimization models generated by the machine learning model based on a first set of optimization problems, each graph representation of the first set of graph representations corresponding to an optimization model of the first set of optimization models based on the corresponding optimization problem of the first set of optimization problems;
obtaining a second graph representation comprises: obtaining a second set of graph representations of a second set of optimization models serving as ground truth for the first set of optimization problems, each graph representation of the second set of graph representations corresponding to an optimization model of the second set of optimization models based on the corresponding optimization problem of the first set of optimization problems; and
obtaining a minimum number of edit operations comprises: obtaining a set of edit operations to transform the first set of graph representations to the second set of graph representations.

11. The computer-implemented method of claim 10 wherein obtaining a set of edit operations to transform the first set of graph representations to the second set of graph representations comprises:
obtaining, for said each optimization problem, a sequence of one or more edit operations of the set of edit operations to transform a corresponding graph of the first set of graph representations to a corresponding graph representation of the second set of graph representations.

12. The computer-implemented method of claim 11 further comprising:
obtaining, a set of graph edit distances (GEDs) corresponding to the set of edit operations, each GED corresponding to said each optimization problem and indicating a measure of the corresponding sequence of the one or more edit operations;
obtaining one or more of:
a ratio of exact match based on the set of GEDs, the ratio of exact match indicating a proportion of the first set of optimization models having a corresponding GED of the set of GEDs indicating an equivalent match; and
a mean of GEDs based on the set of GEDs.

13. The computer-implemented method of claim 10 further comprising:
adjusting one or more weights of the machine learning model based on the set of edit operations, the machine learning model comprising a plurality of nodes connected with one another via a plurality of connections, the machine learning model further comprising the one or more weights corresponding to the plurality of connections.

14. The computer-implemented method of claim 10 further comprising:
generating a training dataset based on the set of edit operations, the training dataset comprising a second set of optimization problems; and
training the machine learning model using the second set of training dataset.

15. A computer-implemented method for evaluating an accuracy of a large language model (LLM), the accuracy being in generating a hypothesis model (HM) of a corresponding linear programming word problem (LPWP), the method comprising:
obtaining, from the LLM, a plurality of HMs corresponding to a plurality of LPWPs, each LPWP of the plurality of LPWPs having associated thereto a respective ground truth model (GTM), all the respective GTMs forming a plurality of GTMs, each HM of the plurality of HMs having associated thereto a respective GTM of the plurality of GTMs;
for each HM of the plurality of HMs:
obtaining a graph of the HM; and
obtaining a graph of the GTM associated with the HM,
the graph of the HM containing HM constraints vertices associated with HM constraints, HM variables vertices associated with HM variables, and HM edges connecting the HM constraints vertices to the HM variables vertices,
the graph of the GTM containing GTM constraints vertices associated with GTM constraints, GTM variables vertices associated with GTM variables, and GTM edges connecting the GTM constraints vertices to the GTM variables vertices;
and
transforming the graph of the HM into the graph of the GTM through a sequence of transformation steps having a total number of transformation steps;
and
calculating a score representing the accuracy of the LLM, the score being a function of all the total numbers of transformation steps for transforming all the HM graphs associated with plurality of HMs into all the respective GTM graphs associated with the plurality of GTMs.

16. A method comprising:
obtaining a first graph representation of a hypothesis optimization problem model generated by a machine learning model based on an optimization problem;
obtaining a second graph representation of a reference optimization problem model based on the optimization problem; and
obtaining a minimum number of edit operations to transform the first graph representation into the second graph representation, the minimum number of operations indicating a performance of the machine learning model.

17. The method of claim 16, wherein:
the machine learning model is a large language model;
the optimization problem is one of:
a linear programming word problem;
a mixed integer linear programming problem;
a quadratic programming problem; and
a quadratically constrained quadratic programming problem;
the first graph representation is a first attributed bipartite graph;
the second graph representation is a second attributed bipartite graph; and
the minimum number of operations is a function of a graph edit distance between the first attributed bipartite graph and the second attributed bipartite graph.

18. The method of claim 16, wherein the optimization problem includes a set of constraints, and a set of decision variables, the method further comprising:
obtaining a first general form of linear programming corresponding to the hypothesis optimization problem model; and
obtaining a second general form of linear programming corresponding to the reference optimization problem model.

19. The method of claim 16, wherein:
the minimum number of edit operations is a minimum sequence of edit operations to transform the first attributed bipartite to the second attributed bipartite graph;
the minimum sequence of edit operations:
relate to one or more of a vertex of the first set of vertices, a vertex of the second set of vertices, an edge of the set of edges; and
comprise one or more of: an insertion operation, a deletion operation, and a substitution operation.

20. The method of claim 16 further comprising:
obtaining a total cost for the minimum sequence of edit operations based on a cost value assigned for each edit operation of the minimum sequence of edit operations, the total cost indicative of the performance of the machine learning model.
